(19) United States
(12) Patent Application Publication
(10) Pub. No.: US 2025/0003100 A1
(43) Pub. Date: Jan. 2, 2025

(54) METHOD OF RECOVERING ACID AND ALKALI FROM RAFFINATE GENERATED FROM METAL EXTRACTION PROCESS

(71) Applicant: SK INNOVATION CO., LTD., Seoul (KR)

(72) Inventors: Yeon Hwa LA, Daejeon (KR); Yong Geal MOON, Daejeon (KR); Tea Young LEE, Daejeon (KR)

(21) Appl. No.: 18/755,714

(22) Filed: Jun. 27, 2024

(30) Foreign Application Priority Data
Jun. 29, 2023 (KR) 10-2023-0084368

(51) Int. Cl. C25C 1/02; C25C 7/04; C25C 7/06

(52) U.S. Cl. CPC C25C 1/02; C25C 7/04; C25C 7/06

(57) ABSTRACT

Proposed is a method of recovering acids and alkalis from raffinate generated from a metal extraction process. The method includes pretreating raffinate generated from a metal extraction process and performing electrodialysis of the pretreated raffinate. The method recovers some components present in raffinate generated from a battery manufacturing process and a battery treatment process to reuse the recovered components. Therefore, the method provides economic and environmental benefits.

### CROSS REFERENCE TO RELATED APPLICATION

The present application claims priority to Korean Patent Application No. 10-2023-0084368, filed Jun. 29, 2023, the entire contents of which is incorporated herein for all purposes by this reference.

### BACKGROUND OF THE DISCLOSURE

### 1. Field of the Disclosure

Embodiments of the present disclosure relate generally to a method of recovering acids and alkali from a raffinate generated from a metal extraction process.

### 2. Description of the Related Art

In recent years, as environmental problems caused by excessive use of fossil fuels have become a global issue, there has been a growing need for transportation that uses alternative, more environmentally friendly fuels, and one of the fastest growing forms of transportation is electric vehicles that use electric energy from batteries, e.g., secondary batteries.

Electric vehicles are equipped with batteries for powering the vehicles, which have a short lifespan of a few years to a maximum of about 10 years because the capacity of the batteries decreases with use.

The rapid adoption of electric vehicles is increasing the amount of wastewater generated globally from the manufacturing process of batteries used in the electric vehicles, as well as the amount of wastewater generated from spent batteries.

### SUMMARY

Embodiments of the present disclosure provide a method of recovering acids and alkalis from a raffinate generated from a metal extraction process.

According to an embodiment of the present disclosure, a method of recovering acids and alkalis from raffinate generated from a metal extraction process may include: pretreating a raffinate generated from a metal extraction process; and performing electrodialysis of the pretreated raffinate.

According to one embodiment of the present disclosure, the raffinate may contain sodium and sulfur.

According to one embodiment of the present disclosure, the raffinate may contain 1% to 25% by weight of sodium and sulfur.

According to one embodiment of the present disclosure, the raffinate may have a pH level in a range of 1 to 8.

According to one embodiment of the present disclosure, the pretreating may include at least one of a flocculation/sedimentation, adsorption, ion exchange, oxidation, or combinations thereof.

According to one embodiment of the present disclosure, the electrodialyzing may be performed with a bipolar membrane, a cationic membrane, an anionic membrane, or any combination thereof.

According to one embodiment of the present disclosure, the electrodialyzing may be performed at a temperature in a range of 15° C. to 55° C.

According to one embodiment of the present disclosure, the method may further include subjecting the raffinate to an electrochemical-advanced oxidation process.

According to one embodiment of the present disclosure, the method may further include microfiltering the pretreated raffinate.

According to an embodiment of the present disclosure, a raffinate treatment method may include: adjusting the pH of a raffinate from a metal extraction process to a pH of from 4 to 8; subjecting the pH adjusted raffinate to a flocculation/sedimentation process for separating substances such as extractants, total phosphorus (TP), salts, heavy metals, and non-degradable organics present in the raffinate by increasing the size of the substances to be separated by sedimentation leaving a treated liquid raffinate; subjecting the treated liquid to adsorption for removing a diluent present in the treated liquid raffinate by an adsorbent; subjecting the treated liquid raffinate from the adsorption to an ion exchange process for separating polyvalent metal ions remaining in the treated liquid raffinate, wherein in the ion exchange process, the polyvalent metal ions in the treated liquid raffinate are precipitated and separated in the form of salts by the addition of an ion exchange solution, and following the ion exchange process regenerated water may be recovered and reused while the treated liquid raffinate from the ion exchange process is subjected to an electrodialysis operation.

According to one embodiment of the present disclosure, the raffinate contains sodium and sulfur.

According to one embodiment of the present disclosure, the raffinate contains sodium and sulfur in a total amount of 1 to 25 wt %.

According to one embodiment of the present disclosure, the raffinate before the pH adjustment has a pH level of 1 to 8.

According to one embodiment of the present disclosure, the raffinate before the electrodialysis process is also subjected to an oxidation process.

According to one embodiment of the present disclosure, the electrodialysis is performed with a bipolar membrane, a cationic membrane, an anionic membrane, or any combination thereof.

According to one embodiment of the present disclosure, the electrodialysis is performed at a temperature of 15° C. to 55° C.

According to one embodiment of the present disclosure, the method may further include performing electrochemical-advanced oxidation on the raffinate.

According to one embodiment of the present disclosure, the method may further include microfiltering the raffinate.

The features and advantages of the present disclosure can be more clearly understood with reference to the following detailed description and the accompanying drawings.

Prior to giving the following detailed description of the embodiments of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe his or her invention in the best way possible.

According to one aspect of the disclosure, there are economic and environmental benefits because acids and alkalis are recovered for reuse from metal extraction raffinates generated in a process of recovering metals from spent batteries.

### BRIEF DESCRIPTION OF THE DRAWINGS

FIG. 1 is a process flow diagram according to an embodiment of the present disclosure;

FIG. 2 is a schematic diagram of an electrodialysis reaction using a bipolar membrane, according to an embodiment of the present disclosure; and

FIG. 3 is a schematic diagram of an electrodialysis reaction using a cationic membrane and an anionic membrane, according to an embodiment of the present disclosure.

### DETAILED DESCRIPTION

The above and other objectives, features, and advantages of the embodiments of the present disclosure will be more clearly understood from the following detailed description taken in conjunction with the accompanying drawings, but the embodiments are not limited thereto. In describing the embodiments of the present disclosure, when the detailed description of the relevant known technology is determined to unnecessarily obscure the gist of the embodiments, the detailed description may be omitted.

Hereinafter, the embodiments of the present disclosure will be described in detail with reference to the accompanying drawings.

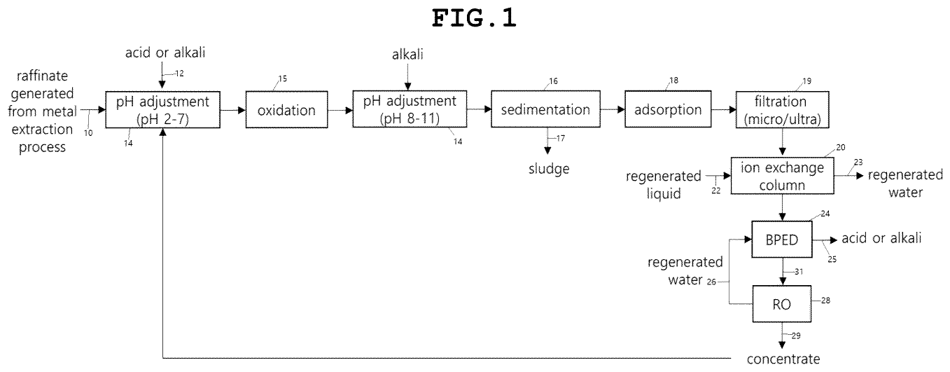

FIG. 1 is a flow diagram according to an embodiment of the present disclosure.

A method of recovering acids and alkalis from raffinate generated from a metal extraction process includes pretreating raffinate generated from a metal extraction process; and performing electrodialysis of the pretreated raffinate. As used herein, the term “raffinate generated from a metal extraction process” refers to wastewater generated from a process for recovering reusable metals from spent batteries, in which the raffinate may be derived using a process for recovering valuable metals, such as, for example, nickel, cobalt, manganese, or combinations thereof, from spent lithium batteries.

According to an embodiment of the present disclosure, the raffinate may contain sodium and sulfur. The raffinate may include, for example, wastewater derived from a process of recovering reusable metals from spent batteries, using chemicals including sodium and sulfur. Thus, the raffinate may contain sodium sulfate as well as an extractant, a diluent, and metal ions.

The processes of recovering valuable metals from spent batteries, which generate the raffinate to be processed according to one embodiment of the present disclosure, include processes of recovering valuable metals from Li(Ni, Co, Mn)O₂ (NCM) spent batteries. The processes may include: discharging spent batteries; physically separating the components of the spent batteries into cathode materials such as copper and aluminum, cathode/anode powders, and plastics; reducing the recovered black powder (cathode active material component) at a high temperature using hydrogen or carbon, and Na₂CO₃; washing the reduced powder; and recovering lithium from the reduced powder. The residue contains nickel, cobalt, and manganese. The residue may undergo a wet extraction process to separately recover nickel, cobalt, and manganese. In the process, phosphoric acid-based extractants or organic acid-based extractants are used, and the extraction process can generate raffinate containing large amounts of salts, especially sulfide salts.

The recovery process from spent batteries entrains an extraction raffinate that may contain hazardous components, or may be strongly acidic and high in salt content, thereby causing water pollution if the extraction raffinate was discharged without being properly treated. Since the extraction raffinate contains large amounts of sodium and sulfur, the extraction raffinate can be a feed for the method of the present disclosure. Waste battery recovery processes similar to those for NCM batteries (Nickel-Cobalt_Manganese batteries) are also performed for LiCoO₂ (LCO) batteries, Li(Ni,Co,Al)O₂ (NCA) batteries, and LiMn₂O₄(LMO) batteries, resulting in the production of an extraction raffinate containing sodium and sulfur. The extraction raffinates generated from the recovery processes from these batteries can be a raffinate feed for the method of the present disclosure.

In one embodiment of the present disclosure, the raffinate from a metal extraction process may contain sodium and sulfur in a total amount of 1 to 25 wt %. When the total content of sodium and sulfur in the raffinate is less than 1 wt %, the low electrical conductivity of the raffinate may reduce the efficiency of subsequent electrodialysis, whereas when the total content of sodium and sulfur content is greater than 25 wt %, sodium sulfate crystallization may occur, causing clogging of the membranes used in electrodialysis.

In one embodiment of the present disclosure, the raffinate may have a pH level of 1 to 8. The process of recovering metals from spent batteries is a process of extracting specific metals by changing the pH level of a solution. For example, when the spent battery is an NCM battery, Mn is first recovered at a low pH level, Co is then recovered by raising the pH level, and finally Ni is recovered, which is performed using a phosphate-based extractant or an organic acid-based extractant. When a phosphate-based extractant is used as an extractant for Ni extraction, the pH level of the extraction raffinate remaining after the Ni recovery can be about 4 to 8. When organic acid-based extractant is used as an extractant, since organic acids are highly soluble in water, an additional operation of reducing the pH level is performed to recover the dissolved organic acids contained in the solution. The pH level of the raffinate remaining after the additional operation may be in a range of 1 to 4.

According to one embodiment of the present disclosure, the process for recovering acids and alkalis from the raffinate generated from a metal extraction process may include pretreating the raffinate. The pretreatment corresponds to purifying the raffinate so that the raffinate becomes a degree suitable for electrodialysis.

In one embodiment of the present disclosure, the pretreatment may include in addition to the pH adjustments 14, oxidation 15, flocculation/sedimentation 16, adsorption 18, ion exchange 20, or any combination thereof. The flocculation/sedimentation process 16 separating substances such as extractants, total phosphorus (TP), salts, heavy metals, and non-degradable organics present in the raffinate by increasing the size of the substances to be separated, in which the size increase is performed by electroflocculation or by the addition of chemicals so that the substances can be easily settle down. More specifically, the flocculation may involve: adding chemicals or eluting metal ions from the electrodes of spent batteries, to form hydroxides of the metal ions; and coagulating and flocculating the contaminants through coagulation-flocculation reactions between the hydroxides with the contaminants present in wastewater. Here, flocs refer to aggregates or agglomerates of the substances such as total phosphorus, salts, heavy metals, and non-degradable organics present in the raffinate, in which the aggregates or agglomerates are formed by electroflocculation, and treated liquid refers to a liquid phase remaining after the flocs are removed from the raffinate.

The sedimentation performed after the flocculation is a stage in which the flocks of harmful substances are separated and removed from the raffinate by the density difference between the liquid and the harmful substances in the raffinate. In one embodiment, the sedimentation may be performed by using any known means for separating the flocs from the raffinate to produce the treated liquid. For example, the sedimentation may be performed by using any known means, such as sedimentation beds and skimmers. After the sedimentation, the flocs separated from the treated water may be discarded or additionally treated as sludge 17. The treated liquid may be introduced into a subsequent operation such as the adsorption operation 18 as shown in example of FIG. 1.

The adsorption process 18 removes the diluent present in the raffinate by adsorption by an adsorbent. Any suitable adsorption method that can separate the treated liquid and the diluent from the raffinate may be used. For example, the adsorption 18 may include filtration 19 using a filter containing an adsorbent. In the illustrated embodiment of FIG. 1, the pretreatment process includes adsorption 18 followed by filtration 19 before the ion exchange process 20 through the ion exchange column. The type of adsorbent is also not limited, and any suitable adsorbent may be used as long as it can adsorb the diluent. For example, activated carbon may be used as the adsorbent.

The ion exchange process 20 corresponds to a process of separating polyvalent metal ions remaining in the treated liquid. In the ion exchange operation, the polyvalent metal ions in the treated liquid are precipitated and separated in the form of salts by the addition of an ion exchange solution. Regenerated liquid 22 may also be added in the ion exchange column 20. Following the ion exchange process 20, regenerated water 23 may be recovered and reused, while the treated liquid may be subjected to an electrodialysis operation 24.

The oxidation may be carried out using chemicals. For example, the oxidation may be performed by Fenton oxidation which involves a catalytic reaction of the raffinate with hydrogen peroxide to produce hydroxyl radicals (OH radicals) or by ozone oxidation which involves the injection of ozone. In addition, any process that oxidizes and removes harmful substances through an oxidation reaction can be used without limitation.

The method of recovering acids and alkalis from the raffinate generated from a metal extraction process, includes the operation of electrodialyzing 24 the pretreated raffinate. The electrodialysis 24 is a process for removing ionic components or salts, such as Na₂SO₄ present in the pretreated raffinate. The electrodialysis 24 may be performed by applying a voltage between two electrodes to dissociate water contained in the pretreated raffinate into H+ and OH— which will bind with the ionic components or salts so that the ionic components or salts can be recovered in acid and alkali forms 25. The apparatus used in the electrodialysis process is not limited to any particular apparatus, provided that it is capable of recovering acids and alkalis from the pretreated raffinate.

In one embodiment of the present disclosure, the electrodialysis of the pretreated raffinate may be performed with the use of a bipolar membrane, a cationic membrane, an anionic membrane, or any combination thereof. A cationic membrane is a membrane with a polymer layer that only allows cations to pass through, an anionic membrane is a membrane with a polymer layer that only allows anions to pass through, and a bipolar membrane is a membrane with two polymer layers one of which allows cations to pass through and the other of which allows anions to pass through. Preferably, the electrodialysis may be performed using a bipolar membrane and may be referred to as bipolar Electrodialysis or “BPED.” Following the electrodialysis 24 a remaining raffinate stream exiting the electrodialysis after the separation of the acids or alkalis 25 is subjected to reverse osmosis (RO) for purifying the water by removing contaminants. The recovered purified water 26 (referred to also as regenerated water) is sent back to the electrodialysis 24. The concentrated raffinate stream 29 (referred to also as the concentrate) is recovered and may be returned to the pH adjustment process 14.

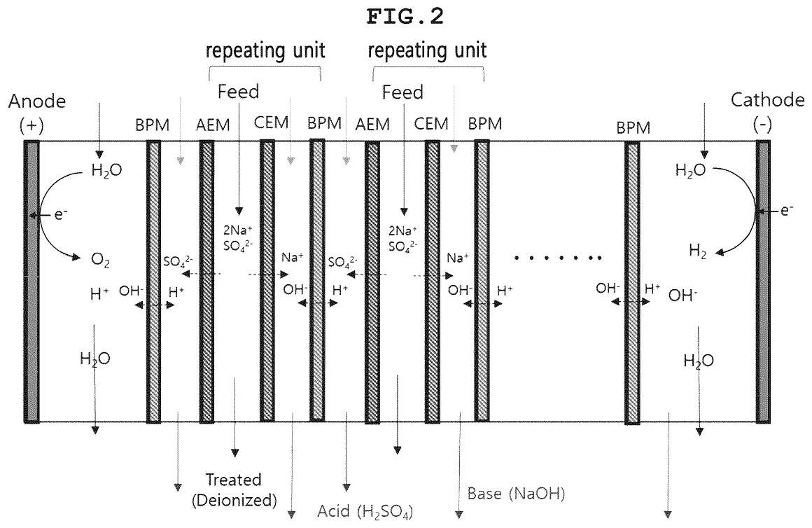

FIG. 2 illustrates a schematic diagram of an electrodialysis operation using a bipolar membrane in accordance with an embodiment of the present disclosure. After water decomposes into H+ and OH-ions at the interface between the cation-transmitting polymer layer and the anion-transmitting polymer layer of the bipolar membrane, the OH-ions combine with Na+ ions produced by the decomposition of Na₂SO₄ to produce NaOH, which is an alkali, and the H+ ions combine with SO₄²— ions produced by the decomposition of Na₂SO₄ to produce H₂SO₄, which is an acid. While conventional membranes are characterized by the selectivity of the substances that can pass through the membranes, bipolar membranes are characterized by the fact that the electrolysis reaction of water occurs at the interface between the cation-transmitting polymer layer and the anion-transmitting polymer layer, rather than at the surface of an electrode. Because of this, bipolar membranes have the advantage of enabling electrodialysis with electrodes at respective ends of a membrane stack, rather than having to install electrodes between each of the membranes in a membrane stack. In addition, since the bipolar membranes can operate at relatively low voltages, device design costs and device operation costs are reduced.

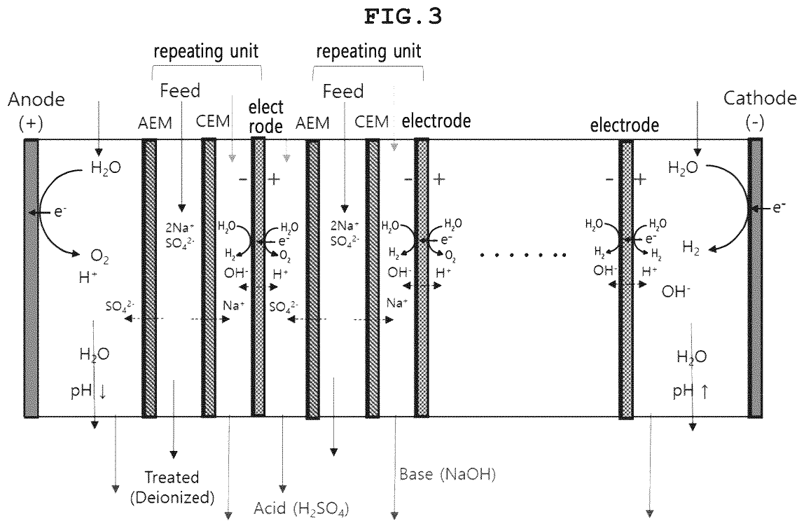

FIG. 3 illustrates a schematic diagram of an electrodialysis step using a cationic membrane and an anionic membrane in accordance with an embodiment of the present disclosure. Unlike the electrolysis using a bipolar membrane, electrodialysis using cationic and anionic membranes requires that electrodes are installed not only at the two ends of the membrane stack but also inside the membrane stack, and a voltage must be applied to electrolyze water. However, the concentrations of acids and alkalis produced by electrodialysis using cationic and anionic membranes are higher compared to the case where electrodialysis is performed with a bipolar membrane.

According to one embodiment of the present disclosure, the electrodialysis may be performed at a temperature in a range of 15° C. to 55° C. Na₂SO₄ contained in raffinate generated from a metal extraction process is crystallized after other harmful substances typically contained in the raffinate are removed by flocculation, filtration, and the like, and then crystallized Na₂SO₄ is used as a chemical in other processes. However, the crystallization of Na₂SO₄ requires a large amount of hot water, which is not efficient in terms of energy consumption. However, according to one embodiment of the present disclosure, Na₂SO₄ contained in the pretreated raffinate of a metal extraction process is recovered through electrodialysis with a bipolar membrane. That is, NaOH, which can be used for saponification of a wet extractant, and Na₂SO₄, which is a wet extractant, are recovered. The electrodialysis is performed at a temperature in a range of 15° C. to 55° C., which is significantly lower than the crystallization temperature of Na₂SO₄. Therefore, the method of the present disclosure is advantageous in terms of energy consumption compared to the conventional Na₂SO₄ crystallization process. The electrodialysis is preferably carried out at a temperature of 20° C. to 50° C. and more preferably at a temperature of 30° C. to 40° C.

According to one embodiment of the present disclosure, the method of recovering acids and alkalis from the raffinate generated from a metal extraction process may further include introducing the electrodialyzed raffinate 31 into reverse osmosis 28 (see FIG. 1). The electrodialyzed raffinate 31 still contains low concentrations of salts, and the reverse osmosis treatment 28 can separate pure water from the electrodialyzed raffinate through a reverse osmosis (RO) membrane. The pure water that is separated is referred to as “regenerated water” 26 which is recirculated back into an electrodialysis unit. The raffinate remaining after the separation of the pure water contains salts and is referred to as “concentrate” 29. The concentrate 29 is transported back to the pretreatment stage and used as a feed for acid and alkali recovery.

According to one embodiment of the present disclosure, the method of recovering acids and alkalis from the raffinate generated from a metal extraction process may further include an electrochemical-advanced oxidation process 15. The electrochemical-advanced oxidation process may be performed before or after the pretreatment process. The electrochemical-advanced oxidation is a process that generates hydroxyl radicals (OH radicals) through electrolysis of water on the surface of an electrode, and utilizes the high reactivity of the hydroxyl radicals to oxidize and remove harmful substances present in wastewater. Any type of electrochemical-advanced oxidation process that oxidizes and removes harmful substances through an oxidation reaction using electrical energy can be used without any limitation.

According to one embodiment of the present disclosure, the method of recovering acids and alkalis from the raffinate generated from a metal extraction process may further include purifying the pretreated raffinate. The purification corresponds to a process for removing microscopic harmful substances remaining in the pretreated raffinate, which have not been removed through the pretreatment process. The purification is not particularly limited in method, provided that the removal of residual contaminants is possible. According to one embodiment of the present disclosure, the purification may preferably be carried out by microfiltration or ultrafiltration. The purification can be performed before or after the pretreatment, and can be performed once or multiple times.

Hereinafter, examples are presented to aid understanding of the embodiments of the present disclosure. However, the following examples are provided only to facilitate easier understanding of the embodiments of the present disclosure, and the embodiments are not limited thereto.

### EXAMPLES

### Example 1: Pretreatment for Electrodialysis of Raffinate Generated from a Metal Extraction Process

An extraction raffinate generated from a waste battery recovery process has characteristics shown in Table 1 below. The extraction raffinate is pretreated by flocculation/sedimentation, oxidation, and ion exchange for the removal of impurities. The extent of removal of total organic carbon (TOC), total phosphorus (TP), and metal in the raffinate pretreated by any combination of the above-mentioned techniques is shown in Table 2 below.

TABLE 1
Characteristics of raffinate generated from a process
of extracting metals from spent batteries

| Component | Value | Unit |
|---|---|---|
| Na₂SO₄ | 15-25 | Wt % |
| P | 5-20 | mg/L |
| Other metals | 100 or more | mg/kg |
| TOC | 70-500 | mg/L |

TABLE 2

| | | Removal | Removal | Removal |
|---|---|---|---|---|
| Technology | Conditions | of TOC | of TP | of metal ions |
| Flocculation/ | Flocculant 800 ppm, | 10% or | 30-40% | Ni > 98.8% |
| sedimentation | Adjuvant 10 ppm, | less | | |
| | @pH > 10 | | | |
| Fenton oxidation/ | H₂O₂ 1200 ppm, | 63.4% | 32.2% | Ni > 89.4% |
| precipitation | Fe 348 ppm, | | | |
| | @pH 10 by | | | |
| | Ca(OH)₂ | | | |
| Ozone oxidation/ | 0.32 g/min, 50 min | 50% | 46.6% | Ni > 89.4% |
| precipitation | @pH 12 by | | | |
| | Ca(OH)₂ | | | |
| Adsorption by | LHSV 0.02 ml/min, | 63-68% | 10% or | 10% or |
| activated carbon | @pH 7 | | less | less |
| Ion exchange | Feeding rate 6.6 | 5% or | 5% or | Mg 97%, |
| | ml/min | less | less | Ni 86.7% |

As shown in Table 2, the raffinates pretreated by each technique of flocculation/sedimentation. Fenton oxidation/sedimentation, ozone oxidation/sedimentation, activated carbon adsorption, and ion exchange showed a reduction in TOC, TP, and metal ion content.

Polyvalent metal ions can form metal hydroxides on the membrane during electrodialysis, thereby causing fouling of the membrane. The pretreatment reduces the content of metal ions, thereby reducing the probability of fouling.

In addition, the metal extractant present in the raffinate is a hydrophobic oil, which can form a hydrophobic film on the membrane surface in the subsequent electrodialysis process, thereby impeding the movement of the ions. The reduced amounts of TOC and TP in Table 2 indicate that the content of the metal extractant present in the raffinate was reduced.

As described above, the pretreatment of the raffinate has the advantage of removing components that negatively affect membrane performance and lifespan in the subsequent electrodialysis process, thereby preventing membrane degradation and enabling long-term operation of the electrodialysis unit.

Herein above, the embodiments of the present disclosure have been described in detail with reference to specific embodiments. Embodiments are intended to illustrate the present invention in detail, however the present invention is not limited thereto. It will be apparent to those skilled in the art that modifications thereto or improvements thereof are possible within the technical spirit of the present disclosure.

The above-described examples and embodiments are in no way intended to be limiting, and modifications and alterations of the embodiments of the present disclosure may be made and falls within the scope of the disclosure. Furthermore, the embodiments may be combined to form additional embodiments.

What is claimed is:

1. A method of recovering acids and alkalis from a raffinate generated from a metal extraction process, the method comprising:
pretreating a raffinate from a metal extraction process; and
performing electrodialysis of the pretreated raffinate.

2. The method of claim 1, wherein the raffinate contains sodium and sulfur.

3. The method of claim 1, wherein the raffinate contains sodium and sulfur in a total amount of 1 to 25 wt %.

4. The method of claim 1, wherein the raffinate has a pH level of 1 to 8.

5. The method of claim 1, wherein pretreating the raffinate involves flocculation/sedimentation, adsorption, ion exchange, oxidation, or a combination thereof.

6. The method of claim 1, wherein the electrodialysis is performed with a bipolar membrane, a cationic membrane, an anionic membrane, or any combination thereof.

7. The method of claim 1, wherein the electrodialysis of the pretreated raffinate is performed at a temperature of 15° C. to 55° C.

8. The method of claim 1, further comprising performing electrochemical-advanced oxidation on the raffinate.

9. The method of claim 1, further comprising microfiltering the pretreated raffinate.

10. A raffinate treatment method, the method comprising:
adjusting the pH of a raffinate from a metal extraction process to a pH of from 4 to 8;
subjecting the pH adjusted raffinate to a flocculation/sedimentation process for separating substances such as extractants, total phosphorus (TP), salts, heavy metals, and non-degradable organics present in the raffinate by increasing the size of the substances to be separated by sedimentation leaving a treated liquid raffinate;
subjecting the treated liquid to adsorption for removing a diluent present in the treated liquid raffinate by an adsorbent;
subjecting the treated liquid raffinate from the adsorption to an ion exchange process for separating polyvalent metal ions remaining in the treated liquid raffinate, wherein in the ion exchange process, the polyvalent metal ions in the treated liquid raffinate are precipitated and separated in the form of salts by the addition of an ion exchange solution, and
following the ion exchange process regenerated water may be recovered and reused while the treated liquid raffinate from the ion exchange process is subjected to an electrodialysis operation.

11. The method of claim 10, wherein the raffinate contains sodium and sulfur.

12. The method of claim 10, wherein the raffinate contains sodium and sulfur in a total amount of 1 to 25 wt %.

13. The method of claim 10, wherein the raffinate before the pH adjustment has a pH level of 1 to 8.

14. The method of claim 10, wherein the raffinate before the electrodialysis process is also subjected to an oxidation process.

15. The method of claim 10, wherein the electrodialysis is performed with a bipolar membrane, a cationic membrane, an anionic membrane, or any combination thereof.

16. The method of claim 10, wherein the electrodialysis is performed at a temperature of 15° C. to 55° C.

17. The method of claim 10, further comprising performing electrochemical-advanced oxidation on the raffinate.

18. The method of claim 10, further comprising microfiltering the raffinate.
